(19) United States
(12) Patent Application Publication
(10) Pub. No.: US 2004/0135939 A1
(43) Pub. Date: Jul. 15, 2004

(54) Liquid crystal display device with light shielding structure and method for forming the same

(76) Inventor: Fang-Chen Luo, Hsinchu (TW)

Correspondence Address: FISH & RICHARDSON PC, 225 FRANKLIN ST, BOSTON, MA, 02110, US

(21) Appl. No.: 10/341,742

(22) Filed: Jan. 14, 2003

(51) Int. Cl. G02F 1/1333

(52) U.S. Cl. 349/110

(57) ABSTRACT

A liquid crystal display (LCD) device with light shielding structure. Light shielding masks are disposed on the TFT substrate along each pixel electrode boundary and parallel to scan lines and data lines, partially overlapping the pixel electrodes. To provide a capacitor for each pixel area, bottom electrodes are a portion of the scan lines and protrude from the scan lines, the bottom electrodes partially overlapping the pixel electrodes. Upper electrodes and the data lines are on the same level and of the same material.

### BACKGROUND OF THE INVENTION

1. Field of the Invention

The present invention relates in general to a flat panel display. In particular, the present invention relates to a liquid crystal display (LCD) device with light shielding structure and method for forming the same.

2. Description of the Related Art

Liquid crystal display (LCD) devices are a well-known form of flat panel display with advantages of low power consumption, light weight, thin profile, and low driving voltage. Generally, in the LCD, a liquid crystal layer is sandwiched between two transparent substrates such as glass substrates, and one of the two transparent substrate is provided with switching devices, such as thin film transistors (TFTs). In the display area of the LCD, an array of pixel areas is defined by horizontally extended scan lines and vertically extended data lines. Each pixel area has a thin film transistor and a pixel electrode.

In these color liquid crystal display devices, a color filter substrate is provided with a black matrix so as to increase display quality such as display contrast of the image.

The black matrix shades the periphery of the display portion of each color picture element of the primary colors R, G and B, adjacent to each other of a color filter to prevent bleeding of each color, such that color mixture is thereby prevented. The black matrix is commonly used to improve the contrast of the color display and to increase the display quality.

However, when the color filter substrate and the TFT substrate are assembled and aligned after processing each substrate separately, slippage of the upper and lower substrates from the proper positions may occur. In such situation, the black matrix cannot effectively reduce light leakage, and light leakage may occur in the uncontrolled liquid crystal molecules over the boundary of the pixel electrodes.

In order to solve this problem with light leakage, Masaaki et al. provide a liquid crystal display device with light-screening films 51 and 52 overlapping the pixel electrode 54 in a peripheral portion adjacent to the signal lines 100a and 100b as disclosed in U.S. Pat. No. 5,561,440, as shown in FIG. 1. Black matrix 108 covers the signal lines 100a and 100b, the scan lines 101a and 101b, the storage capacitance line 106, and the transistor 102 composed of a drain electrode 102a, a source electrode 102b, a gate electrode 102c, and a semiconductor layer 102d. However, light leakage may still occur along the scan lines 101a and 101b, therefore, it has difficulty obtaining a high-definition liquid crystal display device, resulting in lowered contrast ratio.

### SUMMARY OF THE INVENTION

It is therefore an object of the present invention to provide a high-definition liquid crystal display device capable of diminishing light leakage, so as to obtain a high-contrast display.

In order to achieve the foregoing objects, the present invention is constructed to provide a plurality of light shielding masks on the TFT substrate, each light shielding mask disposed along each pixel electrode boundary, parallel to scan lines and data lines, partially overlapping the pixel electrodes.

To provide a capacitor for each pixel area, bottom electrodes are a portion of the scan lines and protrude therefrom, and the bottom electrodes partially overlap the pixel electrodes. Upper electrodes and the data lines are on the same level and of the same material.

The present invention also provides a method for forming a liquid crystal display (LCD) device with light shielding structure. The light shielding masks are formed on the first substrate with scan lines and gate electrodes. A first insulating layer then covers the scan lines, the gate electrodes and the first substrate. A semiconductor layer is formed on the insulating layer for each pixel area. Data lines, source electrodes and drain electrodes are formed on the semiconductor layer and the first insulating layer at the same time. The pixel areas are thus defined by the data lines and the scan lines. A second insulating layer is formed on the data lines, source electrodes, drain electrodes, and first insulating layer. Pixel electrodes connected to the drain electrodes are formed in the pixel areas respectively. The light shielding masks are disposed along each pixel electrode boundary, parallel to the scan lines and the data lines, and partially overlapping the pixel electrodes

### BRIEF DESCRIPTION OF THE DRAWINGS

The preferred embodiment of the invention is hereinafter described with reference to the accompanying drawings in which:

FIG. 1 is a view showing a traditional liquid crystal panel with a light-screening film overlapping a pixel electrode in a peripheral portion adjacent to signal lines.

FIG. 2 shows a top view of the liquid crystal display device with the light shielding mask according to the present invention.

FIG. 3A is a cross section taken along cut line A-A in FIG. 2.

FIG. 3B is a cross section taken along cut line B-B in FIG. 2.

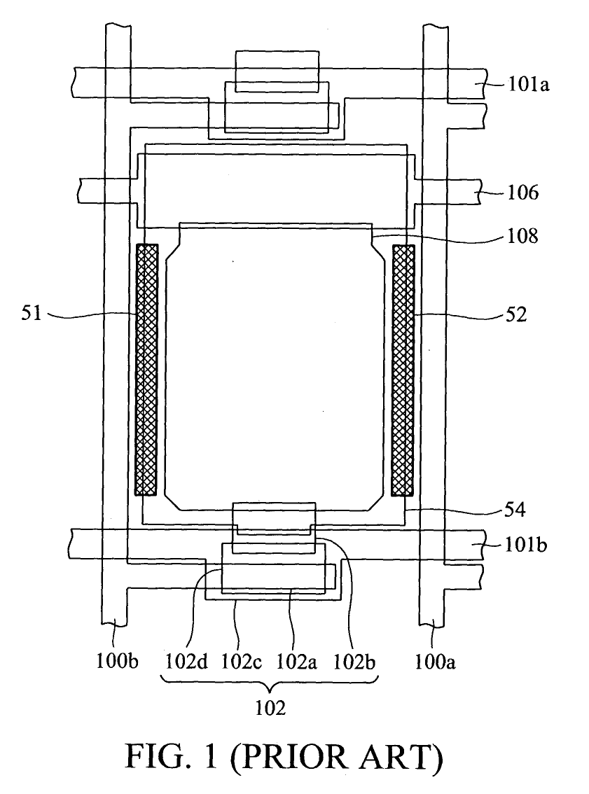

### DETAILED DESCRIPTION OF THE INVENTION

In order to obtain a high-definition liquid crystal display device, a light shielding mask is disposed along the edge of each pixel electrode. A detail description is given hereafter accompanying with figures.

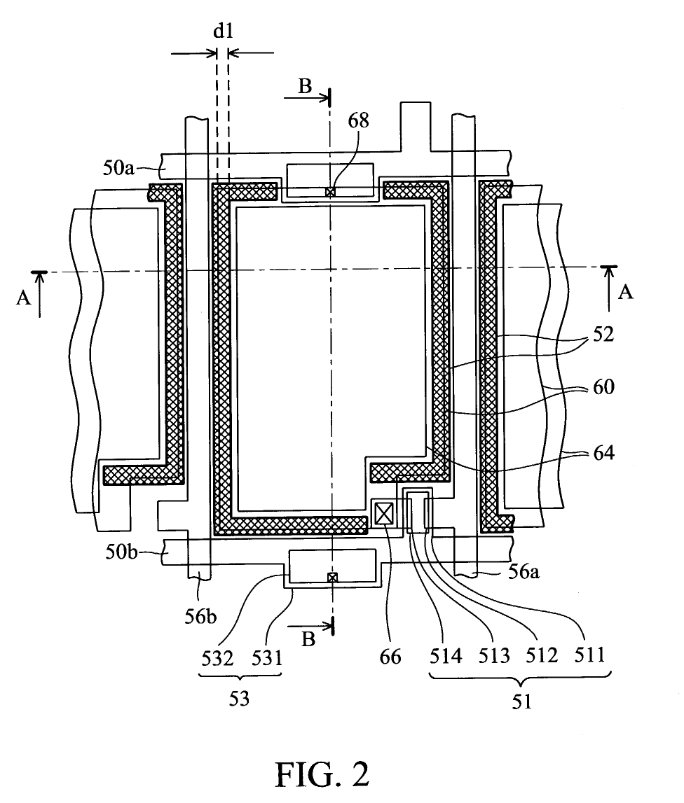

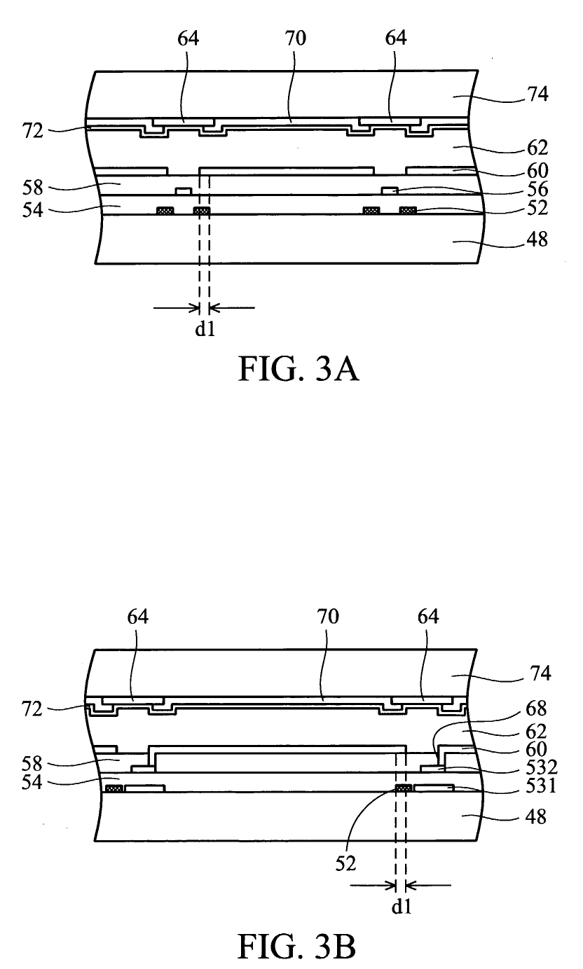

The structure of the high-definition liquid crystal display device according to the present invention is described herewith. FIG. 2 shows a top view of the liquid crystal display device with the light shielding mask according to the present invention. FIGS. 3A and 3B are cross sections taken along cut line A-A and B-B in FIG. 2 respectively. The liquid crystal display device comprises a color filter substrate, a TFT substrate, and a liquid crystal layer 62 therebetween.

As for the TFT substrate, each pixel area comprises a transistor, such as thin film transistor (TFT) 51, capacitor 53 and pixel electrode 60. The transistor 51 at the corner of the pixel area is composed of a drain electrode 512, a source electrode 513, a gate electrode 511 and a semiconductor layer 514. The semiconductor layer 514 is preferably an amorphous silicon (a-Si) thin film transistor and a polysilicon (p-Si) thin film transistor.

Two or more data lines 56a and 56b extend in a column direction. The data lines 56a and 56b are electrically connected to drain electrodes 512 of the thin film transistors 51 so that a voltage controlling the brightness of the liquid crystal is applied to the data lines 56a and 56b.

Two or more scan lines 50a and 50b extend in a row direction applying a voltage for switching the thin film transistors 51 on and off.

The capacitors 53 are dependent of the scan lines 50a and 50b, that is, bottom electrode 531 of each capacitor 53 is formed using a part of the scan lines 50a and 50b. Upper electrode 532 is formed by the same layer as the data lines 56a and 56b.

The light shielding mask 52 is formed by the same layer as the scan lines 50a and 50b, and disposed along the edges of the pixel electrode 60 except over the TFT 51 corner and the capacitor 53. The light shielding mask 52 partially overlaps the pixel electrode 60 by a horizontal distance d₁, such as 3 μm. The light shielding mask 52 and the scan lines 50a and 50b are isolated from each other.

The pixel electrode 60 is a transparent electrode of ITO (indium tin oxide) and is electrically connected to a source electrode 513 and upper electrode 532 of the capacitor 53.

As for the color filter substrate, black matrix 64 is usually disposed on the substrate 74, and covers the area corresponding to the scan lines 50a and 50b, the data lines 56a and 56b, the gate electrodes 511, the source electrodes 513, the drain electrodes 512 and the light shielding masks 52. The black matrix 64 can be not only disposed on the color filter substrate but also disposed on the TFT substrate. The former is used as an example in figures.

A transparent common electrode 72 and a color filter 70 are also disposed on the substrate 74.

The incident light is blocked by the black matrix 64 and the light shielding masks 52, such that light leakage is reduced and a color display with a high contrast ratio is obtained.

A detailed description of fabrication of the TFT substrate is now given.

As shown in FIGS. 3A and 3B, a transparent substrate 48 is provided. A first metal layer (M1), such as Al, Al alloy or multilayered Al/Mo or Ti/Al/Ti, is formed on the transparent substrate 48. After defining the first metal layer using lithography and etching, the light shielding mask 52 and the scan lines 50a and 50b including gate electrode 511 and bottom electrode 531 of the capacitor 53 are formed.

A gate insulating layer 54 is formed on the light shielding mask 52, the scan lines 50a and 50b and the transparent substrate 48. A semiconductor layer 514, as shown in FIG. 2, is formed and patterned on the gate insulating layer 54, and the semiconductor layer 514 can be amorphous silicon or polysilicon. An n-doped layer (not shown) and a second metal layer (M2) are sequentially formed on the semiconductor layer 514 and the gate insulating layer 54. The gate insulating layer 54 can be silicon nitride, and the second metal layer can be Mo or multilayered Mo/Al/Mo. The second metal layer/the n-doped layer are etched by photolithography and etched to form data lines 56a and 56b, source electrodes 513, drain electrodes 512 and upper electrodes 532.

Another insulating layer 58 is formed on the data lines 56a and 56b, source electrodes 513, drain electrodes 512, upper electrodes 532 and gate insulating layer 54. The insulating layer 58 is a low dielectric constant (k) material. Openings 66 and 68 are then formed in the insulating layer 58 to expose the upper electrode 532 and the source electrode 513.

A transparent conducting layer, such as indium tin oxide (ITO), is formed on the insulating layer 58 and fills the openings 66 and 68. The transparent conducting layer is etched to form the pixel electrodes 60 and connect the source electrode 513 and the upper electrode 532 through the openings 66 and 68 respectively.

After forming the TFT substrate, the following processes of fabricating upper substrate 74 with black matrix 64 thereon and filling liquid crystal 62 therebetween follow.

As will be appreciated from the above description, the present invention makes it possible to reduce light leakage resulting from, for example, the slippage of the upper and lower substrates from the proper positions, and resulting in implementing a color display with a high contrast ratio.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited to the particular use contemplated. All such modifications and variations are within the scope of the present invention as determined by the appended claims when interpreted in accordance with the breadth to which they are fairly, legally, and equitably entitled.

What is claimed is:

1. A liquid crystal display (LCD) device with light shielding structure, comprising:
first and second substrates, defining a gap therebetween and sandwiching a liquid crystal layer, the second substrate including at least one color filter and a common electrode thereon;
a plurality of scan lines with a plurality of gate electrodes parallel to each other in a first direction on the first substrate;
a plurality of data lines with a plurality of source and drain electrodes parallel to each other in a second direction substantially perpendicular to the first direction on the first substrate, and a plurality of pixel areas defined by the data lines and the scan lines;
a plurality of pixel electrodes located in the pixel areas respectively on the first substrate, connected to the drain electrodes;
a plurality of light shielding masks disposed on the first substrate, each disposed along each pixel electrode boundary and parallel to the scan lines and the data lines, and partially overlapping the pixel electrodes; and
a black matrix covering the scan lines, the data lines, the gate electrodes, the source and drain electrodes, and the light shielding masks.

2. The liquid crystal display device as claimed in claim 1, further comprising:
a plurality of bottom electrodes included on the scan lines partially overlapped by the pixel electrodes; and
a plurality of upper electrodes corresponding to the bottom electrodes and located between the bottom electrodes and the pixel electrodes.

3. The liquid crystal display device as claimed in claim 2, wherein each pixel electrode connects to the corresponding upper electrode for forming a storage capacitor for each pixel.

4. The liquid crystal display device as claimed in claim 1, wherein the scan lines are Al, Al alloy or multilayered Al/Mo or Ti/Al/Ti.

5. The liquid crystal display device as claimed in claim 1, wherein the light shielding mask and the scan lines are in the same level and of the same material.

6. The liquid crystal display device as claimed in claim 1, wherein the black matrix is disposed on the second substrate.

7. A liquid crystal display (LCD) device with light shielding structure, comprising:
a plurality of scan lines parallel to each other in a first direction;
a plurality of data lines parallel to each other in a second direction, substantially perpendicular to the first direction, and a plurality of pixel areas defined by the data lines and the scan lines;
a plurality of transistors disposed near an interlaced area of the scan lines and the data lines and controlled by the scan lines and the data lines;
a plurality of pixel electrodes in the pixel areas respectively, and controlled by the transistors;
a plurality of light shielding masks, each disposed along each pixel electrode boundary and parallel to the scan lines and the data lines, and partially overlapping the pixel electrodes.

8. The liquid crystal display device as claimed in claim 7, further comprising:
a plurality of bottom electrodes included on the scan lines, partially overlapped by the pixel electrodes; and
a plurality of upper electrodes corresponding to the bottom electrodes and located between the bottom electrodes and the pixel electrodes.

9. The liquid crystal display device as claimed in claim 8, wherein each pixel electrode connects to the corresponding upper electrode.

10. The liquid crystal display device as claimed in claim 7, wherein the scan lines are Al, Al alloy or multilayered Al/Mo or Ti/Al/Ti.

11. The liquid crystal display device as claimed in claim 7, wherein the light shielding mask and the scan lines are on the same level and of the same material.

12. A method for forming a liquid crystal display (LCD) device with light shielding structure, comprising:
providing a first substrate;
forming a plurality of light shielding masks and a plurality of scan lines with a plurality of gate electrodes parallel to each other in a first direction on the first substrate;
forming a first insulating layer covering the scan lines, the gate electrodes and the first substrate;
forming a semiconductor layer for each pixel areas;
forming a plurality of data lines, source electrodes and drain electrodes on the semiconductor layer and the first insulating layer, wherein the data lines are parallel to each other in a second direction substantially perpendicular to the first direction on the first substrates, and the pixel areas defined by the data lines and the scan lines;
forming a second insulating layer on the data lines, source electrodes, drain electrodes, and first insulating layer; and
forming a plurality of pixel electrodes connected to the drain electrodes in the pixel areas respectively,
wherein the light shielding masks are disposed along each pixel electrode boundary and parallel to the scan lines and the data lines, and partially overlapping the pixel electrodes.

13. The method for forming the liquid crystal display device as claimed in claim 12, further comprising:
forming a plurality of bottom electrodes while forming the scan lines and the light shielding masks, wherein the bottom electrodes partially overlap the pixel electrodes; and
forming a plurality of upper electrodes corresponding to the bottom electrodes while forming the data lines.

14. The method for forming the liquid crystal display device as claimed in claim 13, wherein each pixel electrode connects to the corresponding upper electrode.

15. The method for forming the liquid crystal display device as claimed in claim 12, wherein the scan lines, and the shielding masks are Al, Al alloy or multilayered Al/Mo or Ti/Al/Ti.

16. The method for forming the liquid crystal display device as claimed in claim 12, further comprising:
providing a second substrate;
forming a black matrix on the second substrate, covering the area corresponding to the scan lines, the data lines, the gate electrodes, the source and drain electrodes and the light shielding masks;
forming a common electrode on the black matrix and the second substrate; and
assembling the first substrate and the second substrate with a liquid crystal layer therebetween.
